(19) United States
(12) Patent Application Publication
(10) Pub. No.: US 2009/0243785 A1
(43) Pub. Date: Oct. 1, 2009

(54) READER ANTENNA FOR USE WITH RFID TRANSPONDER

(75) Inventors: Frank Deicke, Dresden (DE); Hagen Gratz, Grossweitzschen/Zschepplitz (DE); Wolf-Joachim Fischer, Dresden (DE)

Correspondence Address: BARNES & THORNBURG LLP, 11 SOUTH MERIDIAN, INDIANAPOLIS, IN, 46204, US

(73) Assignee: Fraunhofer-Gessellschaft zur Forderung der angewandten Forschung e.V., Munich (DE)

(21) Appl. No.: 12/408,099

(22) Filed: Mar. 20, 2009

(30) Foreign Application Priority Data
Mar. 28, 2008 (DE) 10 2008 017 490.4

(51) Int. Cl. H01F 17/04; H01F 27/28

(52) U.S. Cl. 336/221; 336/232

(57) ABSTRACT

The invention relates to a reader antenna for use with radio frequency identification (RF ID) transponders. A reader and the transponder are connected to one another via a wireless interface. It is the object of the invention to provide a reader antenna for RFID systems whose transmission range is increased in comparison with a transmission range in a normal air environment without metallic influence with otherwise the same electrical and electromagnetic parameters. The reader antenna in accordance with the invention is provided with an antenna which is formed with a coil having at least one winding. The coil lies on a side of a carrier remote from a transponder and the carrier is made exclusively of a soft magnetic material.

The invention relates to a reader antenna for use with radio frequency identification (RFID) transponders. A reader and the transponder are connected to one another via a wireless interface. In this connection, RFID transponder technology also defines a wireless energy transfer from the reader to transponders in addition to the wireless bidirectional data transmission and thereby differs significantly from other wireless transmission techniques known today. A transponder does not need any separate energy source due to the additional functions. It can be supplied with energy wirelessly by the reader. The transmission of data and energy takes place inductively using an electromagnetic alternating field generated by the reader antenna. A respective antenna each is provided at the reader and at the transponder for the transmission.

The range for the transmission can also be influenced by the size of the antennas in addition to the frequency selected. However, there are very frequently limits to this so that very large antennas cannot be used everywhere.

Antennas for readers are made in the form of coils having at least one winding, are connected to a reader and are fastened to a carrier or arranged in a housing.

Metallic elements which achieve a magnetic shielding effect can also be used as carriers. However, due to the generated electromagnetic alternating field, losses occur as a result of eddy currents and can in turn effect a reduction of the transmission range. To counter this undesirable effect, it has been proposed in EP 1 484 816 A1 to form a layer with a soft magnetic material between the metallic carrier and the antenna, which results in a reduction of the induced eddy currents and an increase in the transmission range. This compensation is, however, not sufficient to reach the transmission range of a comparable antenna used without such an additional carrier structure, that is, in a normal air environment without metallic influences.

It is therefore the object of the invention to provide a reader antenna for RFID systems whose transmission range is enlarged in comparison with a transmission range in a normal air environment without a metallic influence with otherwise the same electrical and electromagnetic parameters.

This object is solved in accordance with the invention by a reader antenna having the features of claim 1. Advantageous embodiments and further developments of the invention can be achieved using features designated in dependent claims. The reader antenna in accordance with the invention for use with RFID transponders has, in an embodiment known per se, a coil which can be connected to a reader and has at least one winding as the antenna. The coil lies on a carrier. In this connection, it is arranged on the side of the carrier facing the transponder, with the carrier accordingly being arranged on the side remote from the transponder. However as a major difference, the carrier is formed exclusively from a soft magnetic material, preferably a ferrite material.

The soft magnetic material should have a small electrical conductivity which should be less than 1 S/m. The carrier can be formed from a MnZn or NiZn ferrite powder having a particle size in the range of 1 μm to 100 μm by means of a sintering process.

The surface of the carrier, i.e. the surface on which the antenna lies, should in this connection be at least so large that the antenna does not project beyond the outer rim of the carrier. However, the surface of the carrier advantageously overlaps the outer rim of the antenna.

A carrier can be made as a plate-shaped element, with the surface on which the antenna lies being able to be flat and planar.

There is, however, also the possibility of forming this surface with contours which take account of the position, geometry and size of the respective antenna.

A carrier can thus have a radially outer rim which is formed as a peripheral flange. The height of the rim should in this connection be larger than the thickness of the carrier in the region on which the antenna lies and the rim should engage around the antenna.

In another embodiment, a groove-shaped recess in which the antenna is arranged can be formed at the carrier. The recess can inwardly adjoin the peripheral outer rim. A core is then formed in the interior of the antenna at the carrier and forms the inner termination of the groove-shaped recess. The antenna is then arranged between the margin and the core. The winding(s) is/are thus received in the recess.

In this embodiment, the heights of the rim and of the core should be larger than the thickness of the carrier in the region of the recess.

In a further suitable embodiment, the carrier can, however, also have a concavely curved surface so that a recess shaped in this manner is formed at this surface. The antenna can then be arranged therein.

With a carrier present at a reader antenna in accordance with the invention, the formed electromagnetic field can be influenced directly and can be deflected in the direction of a transponder so that it quasi forms a reflector and focuses the magnetic field in the direction of a transponder.

As already addressed, the antenna can also be made with a plurality of windings. They can be formed as a planar, single layer or multilayer cylinder coil. The winding shape can be circular, elliptical or n-cornered.

The transmission range can also be further increased with the invention with respect to antennas which are operated in a normal air atmosphere without further additional measures having to be taken and electrical or electromagnetic parameters having to be changed.

The invention will be explained in more detail by way of example in the following.

There are shown:

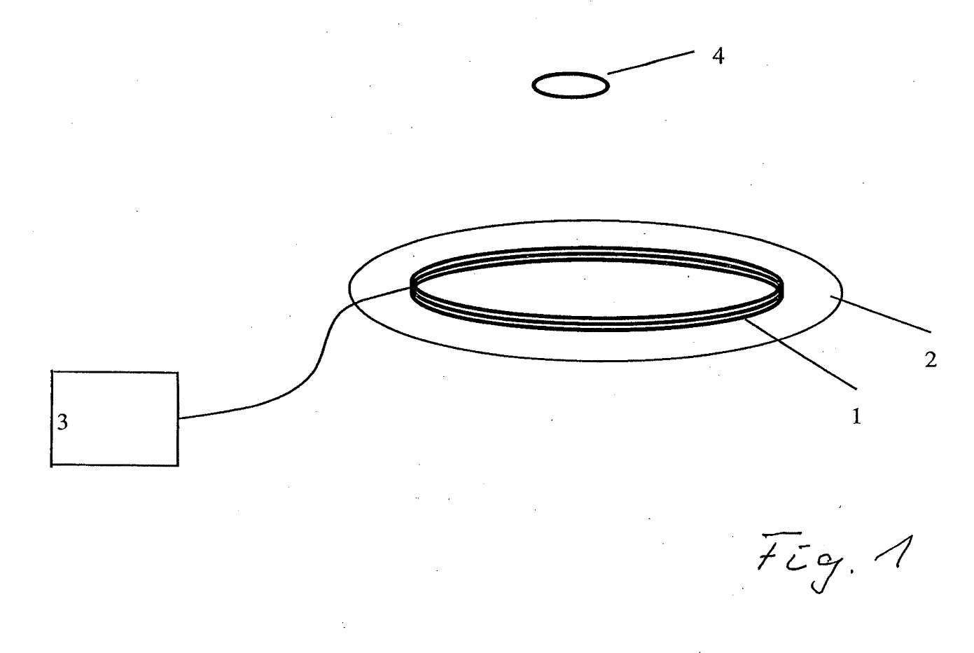

FIG. 1, in schematic form, the design with a reader, a reader antenna and a transponder;

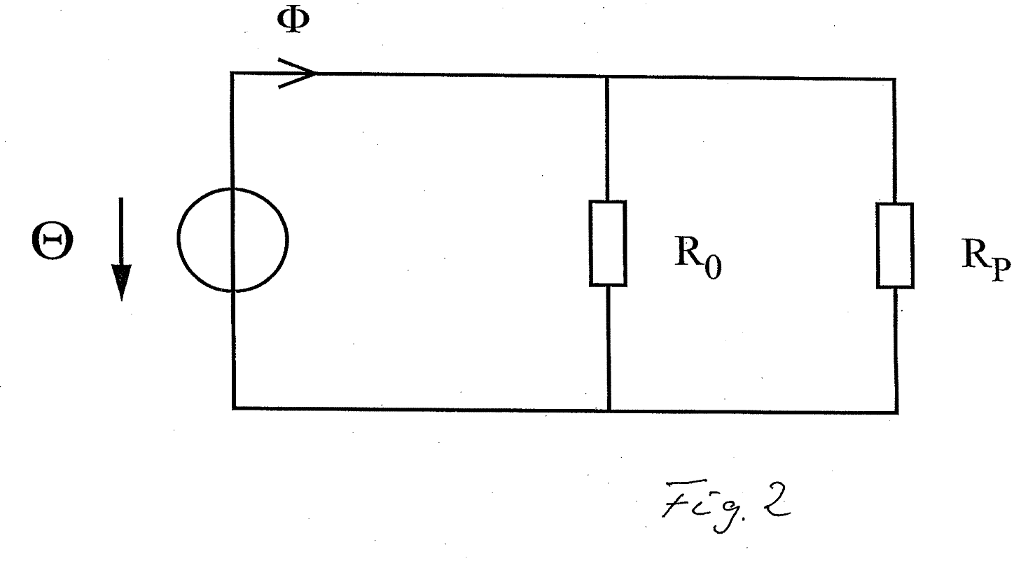

FIG. 2 an equivalent circuit diagram of the reader antenna in accordance with the invention;

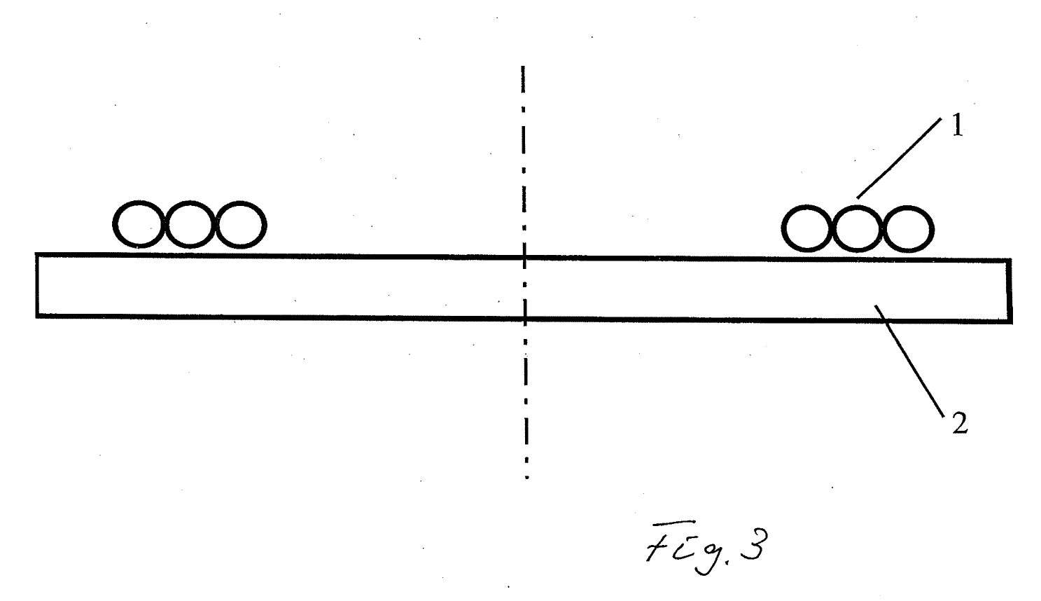

FIG. 3 a schematic representation of an example of a reader antenna with a plate-like carrier;

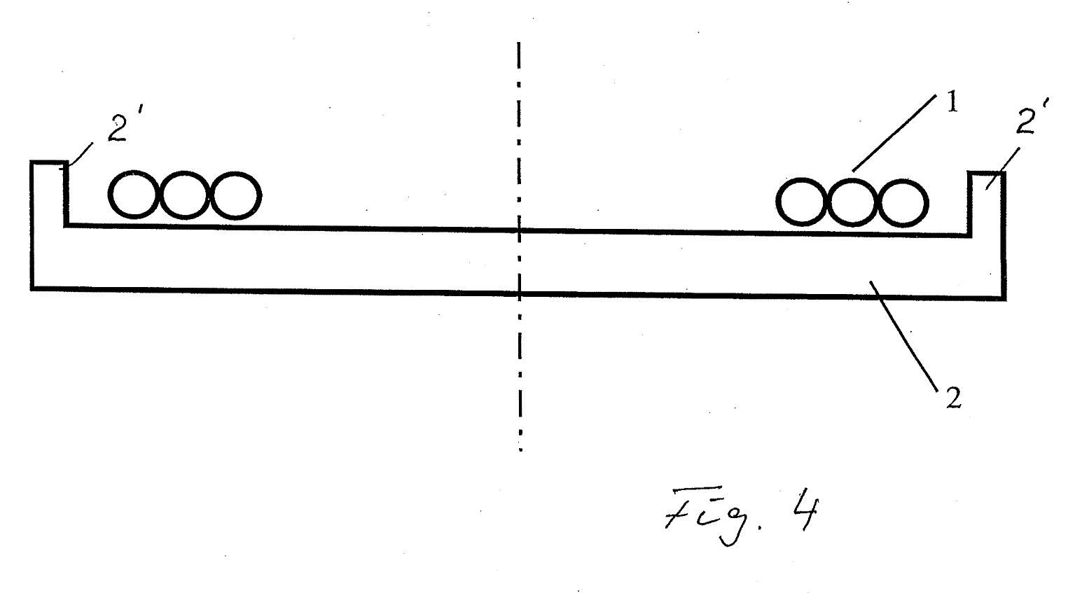

FIG. 4 a schematic representation of a further example of a reader antenna with a carrier which has a radial outer rim; and

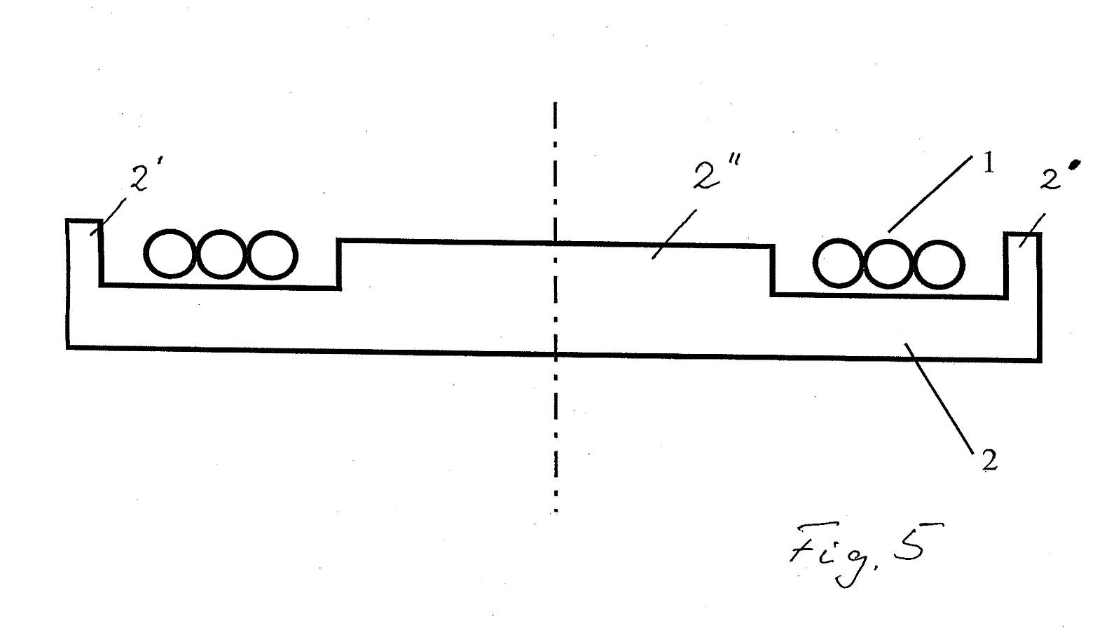

FIG. 5 a schematic representation of a further example of a reader antenna with a carrier at which a recess is formed.

FIG. 1 shows an arrangement with a reader 3 which is connected in an electrically conductive manner to a coil having a plurality of windings and forming an antenna 1. The antenna 1 is arranged on a carrier 2 which is here plate-shaped and circular and is formed of sintered MnZn. The outer diameter of the carrier 2 is larger than the radially outer rim of the antenna 1 so that the antenna is overlapped by it. A radio frequency electrical alternating field is generated by the reader 3 and a corresponding electromagnetic field is thus formed via the antenna 1. It can be utilized in a manner known per se for energy transmission to a passive transponder 4 and for reception of the information from the transponder 4.

The electrical conductivity of the material MnZn selected for the carrier 2 was 0.33 S/m.

It becomes clear with the equivalent circuit diagram shown in FIG. 2 that the reluctance R_{O} in the environment, that is e.g. air, and the additional reluctance R_{P} of the carrier can be considered as connected in parallel. The reluctance R_{P} is determined by the size of the carrier 2, by the material properties and by the distance from the antenna 1. The total reluctance is reduced by the parallel circuit. The electromagnetic energy in the room therefore increases in accordance with

W_{mag}=θ²/R_{O}∥R_{P}.

The electrical current flow through the antenna 1 remains constant.

The electromagnetic energy can, however, also be calculated by

W_{mag}=½LI²

Under the conditions selected, the inductivity L of the antenna 1 increases, which in turn results in the increase of the electromagnetic field strength in the room and of the counter-inductivity M between the reader 3 and the transponder 4.

A reader antenna analog to the example of FIG. 1 is shown in FIG. 3. In this respect, however, the outer rim geometry of the carrier 2 can optionally be selected not to be rotationally symmetrical. The carrier 2 is made as a planoparallel plate and the windings of the coil forming the antenna 1 are arranged directly at the one surface of the carrier 2 and can be fastened there, for example, using an organic material, preferably an electrically non-conductive material.

In the example shown in FIG. 4, an outwardly circumferential flange-like rim 2′ is formed at the carrier 2 which engages around the antenna 1. The rim 2′ has a height which is larger than the thickness of the carrier 2 in the region in which the antenna 1 is arranged. The rim 2′ which projects over the middle part of the carrier 2 on which the windings of the antenna 1 lie is therefore higher than the thickness of the carrier 2 in its middle part.

In the example shown in FIG. 5, a recess is formed at the carrier 2, said recess being circular here and with the antenna 1 being received therein. A core 2″ is thus formed at the center of the antenna 1 and the carrier 2.

The axes standing perpendicular on the antenna 1 and the carrier 2 should be aligned parallel to one another.

The following tabular list is intended to show parameters which can achieved with the invention in comparison with an antenna 1 at air without a carrier 2 in accordance with the invention or a different kind of metallic or metal-containing carrier 2 or a housing.

The following same parameters were observed in this connection:

The antenna 1 was a planar cylinder coil having ten windings. The inner radius was 65 mm and the outer radius was 90 mm. A carrier frequency of 125 kHz was observed. The carrier 2 had a minimum thickness of 3 mm and was formed with MnZn. The antenna resonant circuit in the reader is attuned to the resonant frequency of 125 kHz, has a quality of 12.5 and is operated with an electric AC voltage having an amplitude of 6 V. The antenna resonant circuit in the reader 3 is a series resonant circuit.

| | | | Transmission |
|---|---|---|---|
| | L [μH] | M [μH] | range [m] |
| Air | 27 | 0.77 | 0.159 |
| FIG. 3 | 39.9 | 1.1 | 0.185 |
| FIG. 4 | 42.4 | 1.14 | 0.187 |
| FIG. 5 | 43.5 | 1.19 | 0.192 |

1. A reader antenna for use with RFID transponders, wherein the antenna is formed by a coil having at least one winding and lying on a side of a carrier remote from a transponder, the carrier consisting of a soft magnetic material.

2. A reader antenna in accordance with claim 1 wherein the carrier consists of a ferrite material.

3. A reader antenna in accordance with claim 1 wherein the carrier includes a surface which is at least so large that the antenna does not project beyond the surface.

4. A reader antenna in accordance with claim 1 wherein the soft magnetic material has an electrical conductivity <1 S/m.

5. A reader antenna in accordance with claim 1 wherein the carrier is formed using at least one of MnZn ferrite powder and NiZn ferrite powder.

6. A reader antenna in accordance with claim 1 comprising a peripheral flange-like rim formed at the radially outer rim of the carrier, the rim having a height and the carrier having a thickness, the height being larger than the thickness and the rim engaging around the antenna.

7. A reader antenna in accordance with claim 1 wherein the carrier includes a groove-shaped recess formed in the carrier, the antenna being arranged within the groove-shaped recess, the carrier further including a peripheral flange-like outer rim and an inner core between which the antenna is arranged.

8. A reader antenna in accordance with claim 7 wherein the carrier includes a thickness in the region of the recess, the outer rim includes a height, the core includes a height, and the heights of the outer rim and of the core are larger than the thickness of the carrier in the region of the recess.

9. A reader antenna in accordance with claim 1 wherein the carrier has a concavely curved surface and the antenna is arranged within the recess formed by the concavely curved surface.

10. A reader antenna in accordance with claim 1 wherein the carrier further includes a peripheral flange-like outer rim including a height and an inner core including a height, the antenna includes a height, and at least one of the outer rim and the core projects beyond the height of the antenna.

11. A reader antenna in accordance with claim 2 wherein the carrier includes a surface which is at least so large that the antenna does not project beyond the surface.

12. A reader antenna in accordance with claim 2 wherein the soft magnetic material has an electrical conductivity <1 S/m.

13. A reader antenna in accordance with claim 3 wherein the soft magnetic material has an electrical conductivity <1 S/m.

14. A reader antenna in accordance with claim 11 wherein the soft magnetic material has an electrical conductivity <1 S/m.

15. A reader antenna in accordance with claim 2 wherein the carrier is formed using at least one of MnZn ferrite powder and NiZn ferrite powder.

16. A reader antenna in accordance with claim 3 wherein the carrier is formed using at least one of MnZn ferrite powder and NiZn ferrite powder.

17. A reader antenna in accordance with claim 4 wherein the carrier is formed using at least one of MnZn ferrite powder and NiZn ferrite powder.

18. A reader antenna in accordance with claim 11 wherein the carrier is formed using at least one of MnZn ferrite powder and NiZn ferrite powder.

19. A reader antenna in accordance with claim 12 wherein the carrier is formed using at least one of MnZn ferrite powder and NiZn ferrite powder.

20. A reader antenna in accordance with claim 13 wherein the carrier is formed using at least one of MnZn ferrite powder and NiZn ferrite powder.
